(19) United States
(12) Patent Application Publication
(10) Pub. No.: US 2023/0108941 A1
(43) Pub. Date: Apr. 6, 2023

(54) AN EDIBLE FOOD PRODUCT OF INCREASED BIOLOGICAL VALUE PREPARED FROM LYOPHILISED POWDER

(71) Applicant: UAB GELD BALTIC, Panevézys (LT)

(72) Inventor: Laura Kaziukoniené, Bukiskis, Vilniaus raj. (LT)

(21) Appl. No.: 17/043,399

(22) PCT Filed: Nov. 19, 2019
(86) PCT No.: PCT/IB2019/059926

§ 371 Date: Sep. 29, 2020

(51) Int. Cl. A23G 3/40; A23L 3/44; A23G 3/44

(52) U.S. Cl. CPC A23G 3/40; A23L 3/44; A23G 3/44

(57) ABSTRACT

The present invention relates to the field of the food industry, which describes invented formulas for food products made from a particularly high amount of lyophilized powder and a technology for their production. Foods produced of freeze-dried powder, vegetable butter and protein isolates (with or without the addition of natural spices) have a natural character, particularly high biological activity and a long shelf life. These foods can be consumed as candy, snacks, or individual meal pack. Unique manufacturing technology does not require additional lyophilization after formulation, thus it is fast and efficient.

### BACKGROUND OF THE INVENTION

The present invention relates to the field of the food industry, which describes invented formula for edible food products made from a particularly high amount of lyophilized powder and a technology for their production.

### TECHNICAL FIELD

The popularity of freeze-dried fruits and vegetables has grown rapidly in recent years. This is due to the fact that such products have been products of unprocessed fruits, vegetables or spices that retain their color, aroma and nutritional value and do not contain added sugar.

Freeze-dried fruits and vegetables are known as a snack that retains vitamins for a long time. In addition, the freeze-dried fruits, berries and spices are incredibly lightweight, with high concentration of energy and can be used instead of meals.

One of the major obstacles for making such snacks is the use of binders, which “glues” all the ingredients together without negatively affecting the taste of the product and makes it easier to swallow. Most of such products, being manufactured currently, contain binders with high sugar content.

Some of the most widely used sugars are glucose, fructose, sugar, honey, rice syrup and many others. However, the high sugar content is often undesirable for consumers. In addition, sugar binders are usually processed at high temperatures which reduce the amount of vitamins retained in the product.

CN106722959 describes a dietary supplement for infants and a method for its production. The dietary supplement is made out of tofu, nutrition enhancer, soy protein isolate, freeze-dried apple powder, banana powder, carrot powder and milk powder. However, it is a powdery product.

US2016095329 describes an edible snack having low content of water and large content of dry materials and a method for its production. To produce the snack a porous material such as a freeze-dried fruit or vegetable, or an extruded grain product is used. The material then is coated with 25% whey protein isolate.

The disadvantage of the inventions is that lyophilized powder cannot be eaten usually: they tend to stick to the walls of the mouth and throat. If the powder is compressed into a pill, a subject could choke while swallowing it. Thus, natural products have been used to design a connective compound that, when mixed with a large amount of powder, forms an easily absorbed healthy food.

### BRIEF DESCRIPTION OF THE INVENTION

The present invention relates to the field of the food industry, which describes invented formula for edible food products made from a particularly high amount of lyophilized powder and a technology for their production. Unique manufacturing technology does not require any additional lyophilization after the formulation, is fast and efficient. These food products can be consumed as a candy, snacks, or dry portions. Edible food products produced from freeze-dried powder, vegetable butter and protein isolates (with or without the addition of natural spices) have a natural character, particularly high biological activity and a long shelf life.

One of the main objects of this invention is an edible food product comprised of vegetable butter, protein isolates and the lyophilized powder which has an average dry matter content of said product from 10% to 75%, preferably from 20% to 50% of the total weight of the product.

Preference is given to an edible food product which comprises vegetable butter, preferably where the vegetable butter is cocoa butter.

Preference is given to a product comprising protein isolates which are of plant and/or animal origin, preferably isolate of plant origin.

Preference is given to a product which comprised of a lyophilized powder which is a powder of plant and/or animal origin.

In another embodiment of the invention, the vegetable butter is present in said product in an amount of 20% to 85%, preferably from 30% to 50% by weight of the total composition.

In the farther embodiment of the invention, the amount of protein isolates in the product is from 2% to 20%, preferably from 5% to 10%, by weight of the total product.

Preference is given to a product that additionally includes natural spices.

Another object of the invention is a process for the preparation of said product, comprising the following steps:

a) melting the vegetable butter at a temperature of 20-40° C.;
b) mixing the ingredient obtained in step a) with a protein isolate and further heating;
c) mixing the mixture obtained in step b) with a lyophilized powder of plant/animal origin (and natural spices);
d) dispensing the resulting mixture into molds and rapidly cooling to 0-15° C.

In another embodiment of the invention, steps a), b), and c) are carried out at a temperature of 20 to 40° C.

In the farther embodiment of the invention, step d) is carried out at a temperature of 0° C. to 20° C. over a period of time of 0.1 s to 10 min.

Optionally, natural spices can be added during manufacturing process of a product.

The food product as the subject of the invention is used for the preparation of snacks, food tablets, sweets, individual meal pack and the like.

### DETAILED DESCRIPTION OF THE INVENTION

Before explaining in detail at least one embodiment of the invention, it should be understood that the invention is not to be limited to the details set forth herein or in the examples provided. The invention can be implemented in other ways or may be practiced or implemented in various ways.

The products of plant and/or animal origin selected first are exposed to lyophilization. This means the preservation of fruits, berries, spices and other products by deep cooling (up to −80° C.) followed the removal of the moisture by sublimation in a vacuum. As the moisture from the ice converts into the vapor, bypassing the liquid state, fruits and berries dry out preserving their physical form, flavor, nutritional qualities and vitamins.

A completely natural product, free of preservatives such as sugar is obtained. The taste remains almost the same and, as we know, this is not the case for heat-treated or conventionally dried fruit and vegetables.

A large amount of freeze-dried powder was combined with protein isolate and cocoa butter during the production of this product, and unexpectedly an easy-to-eat snack was discovered.

Primarily, lyophilized powders are prepared from raw material of vegetable and/or animal origin. Vegetable raw materials comprise nutritious raw materials such as fruits, berries, vegetables, nuts, cereals, algae and others. Animal raw materials comprise nutritious raw materials such as meat, fat, eggs, honey, fish, seafood and others. The raw material is frozen to −80° C. then placed in a lyophilizer where moisture is removed by the help of a vacuum. By drying the raw material in this way, virtually all vitamins remain and the product has a very long shelf life (as mold does not propagate due to the dryness), the product is 100% natural and 10 times lighter than the raw material.

The lyophilized product is ground and a powder is obtained which is used to produce the product. Compressed lyophilized powder provides high energy value of 100% natural products in a low weight and volume.

Cocoa butter (40%) is dissolved at about 35-40° C. and then mixed with pea protein isolate (5%). Further heating is carried out by admixing said prepared lyophilized powder (50%). After thorough mixing, the resulting mixture is dispensed into molds and cooled rapidly, at about −18° C., for about 15 minutes.

The resulting product has valuable nutritional properties, in particular high biological activity and long shelf life.

1. An edible food product comprising vegetable butter and protein isolates, wherein the product further comprises a lyophilized powder having a dry matter content of 10% to 75%, preferably from 20% to 50% of the total weight of the product.

2. An edible food product according to claim 1, wherein the vegetable butter is cocoa butter.

3. An edible food product according to claim 1, wherein the protein isolates are of plant and/or animal origin.

4. An edible food product according to claim 1, wherein the lyophilized powder is a powder of plant and/or animal origin.

5. An edible food product according to claim 1, wherein the amount of vegetable butter in said product is from 10% to 85%, preferably from 30% to 50% by weight of the total composition.

6. An edible food product according to claim 1, wherein the amount of protein isolates in the product is from 2% to 20%, preferably from 5% to 10% by weight of the total product.

7. An edible food product according to claim 1, wherein the product farther comprises natural spices.

8. A method of producing an edible food product, wherein said method comprises the steps of:
a) melting the vegetable butter at a temperature of 20-40° C.;
b) mixing the ingredient obtained in step a) with a protein isolate and further heating;
c) mixing the mixture obtained in step b) with a lyophilized powder of plant/animal origin (and natural spices);
d) dispensing the resulting mixture into molds and rapidly cooling to 0-20° C.

9. A process according to claim 9, wherein steps a), b), and c) are carried out at a temperature of 20 to 40° C.

10. The process according to claim 9, wherein step d) is carried out at 0 to 20° C. over a period of time of 0.1 s to 10 min.

11. Method according to claim 9, wherein it further comprises the addition of natural spices.

12. An edible food product according to claim 1, for use in the manufacture of sweets, snacks and individual meal pack and similar products.
